(19) United States
(12) Patent Application Publication
(10) Pub. No.: US 2026/0181535 A1
(43) Pub. Date: Jun. 25, 2026

(54) GENERATING CELL CONFIGURATION INFORMATION

(71) Applicant: Nokia Technologies Oy, Espoo (FI)

(72) Inventors: Shehzad Ali ASHRAF, Munich (DE); Umur KARABULUT, Munich (DE); Srinivasan SELVAGANAPATHY, Bangalore (IN); Halit Murat GÜRSU, Munich (DE); Panagiotis SPAPIS, Munich (DE)

(21) Appl. No.: 19/126,906

(22) PCT Filed: Oct. 18, 2023
(86) PCT No.: PCT/EP2023/078985

§ 371 Date: May 2, 2025

(30) Foreign Application Priority Data
Nov. 4, 2022 (IN) 202241063027

(51) Int. Cl. H04W 48/16; H04W 36/00

(52) U.S. Cl. CPC H04W 48/16; H04W 36/0061; H04W 36/0085

(57) ABSTRACT

A user equipment of a telecommunications network comprises: at least one processor; and at least one memory storing instructions that, when executed by the at least one processor, cause the user equipment at least to: establish a connection between the user equipment and a first network node of the radio access network, the first network node supporting a first cell, derive in the user equipment a full configuration of the first cell, receive in the user equipment first delta configuration information related to a cell change from the first cell towards a second cell and second delta configuration information related to a cell change from the first cell towards a third cell, in response to a cell change towards the second cell, derive a full configuration of the second cell based on the full configuration of the first cell and the first delta configuration information to connect to the second cell, and generate updated second delta configuration information for performing a cell change from the second cell towards the third cell, the generation of the updated second delta configuration information being based on the configuration information available to the user equipment prior to the cell change towards the second cell.

### TECHNOLOGICAL FIELD

Various example embodiments relate to generating cell configuration information in a wireless telecommunications network.

### BACKGROUND

In some wireless telecommunications networks, a cell change is facilitated by having configuration information of the candidate or target cell(s) that the are to be used for the cell change. Although techniques exist for providing such configuration information, they each have their own shortcomings. Accordingly, it is desired to provide an improve technique.

### BRIEF SUMMARY

The scope of protection sought for various example embodiments of the invention is set out by the independent claims. The example embodiments and features, if any, described in this specification that do not fall under the scope of the independent claims are to be interpreted as examples useful for understanding various embodiments of the invention.

According to various, but not necessarily all, example embodiments of the invention there is provided a user equipment of a telecommunications network comprising: at least one processor; and at least one memory storing instructions that, when executed by the at least one processor, cause the user equipment at least to: establish a connection between the user equipment and a first network node of the radio access network, the first network node supporting a first cell, derive in the user equipment a full configuration of the first cell, receive in the user equipment first delta configuration information related to a cell change from the first cell towards a second cell and second delta configuration information related to a cell change from the first cell towards a third cell, in response to a cell change towards the second cell, derive a full configuration of the second cell based on the full configuration of the first cell and the first delta configuration information to connect to the second cell, and generate updated second delta configuration information for performing a cell change from the second cell towards the third cell, the generation of the updated second delta configuration information being based on the configuration information available to the user equipment prior to the cell change towards the second cell.

The generation of the updated second delta configuration information may be based on the full configuration of the first cell, the first delta configuration information and the second delta configuration information.

The generation of the updated second delta configuration information may be based on the full configuration of the first cell, the full configuration of the second cell and the second delta configuration information.

The generating may occur following the cell change from the first cell to the second cell.

The generating may occur between the cell change from the first cell to the second cell and a subsequent cell change.

The generating may identify differences between the first delta configuration information when applied to the full configuration of the first cell and the second delta configuration information when applied to the full configuration of the first cell and may incorporate those differences into the updated second delta configuration.

The generating may identify when an element or parameter has a different value in the second delta configuration information to a corresponding element or parameter in the first delta configuration information and may incorporate the different value from the second delta configuration information for the element or parameter into the updated second delta configuration information.

The generating may identify when an element or parameter in the first delta configuration information has no a corresponding element or parameter in the second delta configuration information and may incorporate a corresponding element or parameter from the full configuration of the first cell into the updated second delta configuration information.

The generating may identify when an element or parameter in the first delta configuration information has no a corresponding element or parameter in the full configuration of the first cell and may incorporate an indication into the updated second delta configuration information that the element or parameter should be removed.

The instructions may cause the user equipment at least to: in response to a further cell change towards the third cell, derive a full configuration of the third cell based on the full configuration of the second cell and the updated second delta configuration to connect to the third cell.

The instructions may cause the user equipment at least to: repeat the generating of updated delta configuration information in response to the further cell change to the third cell.

The instructions may cause the user equipment at least to: receive the full configuration of the first cell, the first delta configuration information and/or the second delta configuration information using RRC signalling.

The first network node may comprise at least one of or support functionality of at least one of: a base station, a 5G gNB, a Centralised Unit, a Distributed Unit, a secondary node, a source node or a source secondary node.

The user equipment may support dual connectivity to a master node and a secondary node.

The first cell may be at least one of a primary secondary cell or primary secondary cell supported by a source secondary node, or a source primary secondary cell, or a currently serving cell.

The second cell may be at least one of a primary secondary cell or primary secondary cell supported by a first target secondary node, or a target primary secondary cell, or a target serving cell.

The third cell may be at least one of a primary secondary cell or primary secondary cell supported by a second target secondary node, or a target primary secondary cell, or a target serving cell.

The instructions may cause the user equipment at least to: receive information related to a conditional cell PSCell change for moving from the first to the second cell and, if the condition for the cell PSCell change to the second cell holds, then perform random access to the second cell.

The instructions may cause the user equipment at least to: when random access to the second cell is successful, store the updated second delta configuration information and delete the second delta configuration information.

The instructions may cause the user equipment at least to: receive information related to a conditional cell PSCell change for moving from the first to the third cell and, if the condition for the cell PSCell change to the third cell holds, then perform random access to the third cell.

The user equipment may be configured for subsequent selective activation.

The user equipment may be configured using at least one RRC reconfiguration message.

The instructions may cause the user equipment at least to: receive configuration information for performing L1 measurements.

The instructions may cause the user equipment at least to: send an L1 measurement report including second cell information towards the first cell or source network node and receiving a trigger to handover to the second cell.

The user equipment may be configured for dynamic switching.

According to various, but not necessarily all, example embodiments of the invention there is provided a user equipment of a telecommunications network comprising: at least one processor; and at least one memory storing instructions that, when executed by the at least one processor, cause the user equipment at least to: establish a connection between the user equipment and a first network node of the radio access network, the first network node supporting a first cell, derive in the user equipment a full configuration of the first cell, receive in the user equipment first delta configuration information related to a cell change from the first cell towards a second cell and second delta configuration information related to a cell change from the first cell towards a third cell, and further receive in the user equipment updated second delta configuration information related to a cell change from the second cell towards the third cell prior to the cell change towards the second cell.

The instructions may cause the user equipment at least to: in response to a cell change towards the second cell, derive a full configuration of the second cell based on the full configuration of the first cell and the first delta configuration information to connect to the second cell.

The instructions may cause the user equipment at least to: in response to a subsequent cell change towards the third cell, deriving a full configuration of the third cell based on the full configuration of the second cell and the updated second delta configuration information to connect to the third cell.

The instructions may cause the user equipment at least to: receive the full configuration of the first cell, the first delta configuration information, the second delta configuration information and/or the updated second delta configuration information using RRC signalling.

The first delta configuration information, the second delta configuration information and/or the updated second delta configuration information may be received within a single RRC message.

The first delta configuration information, the second delta configuration information and/or the updated second delta configuration information may be received within a nested RRC message.

The instructions may cause the user equipment at least to: receive updated second delta configuration information while being connected to the first cell and before determining to perform a cell change.

The instructions may cause the user equipment at least to: further receive a fourth delta configuration information related to a cell change from the second cell towards the first cell.

The instructions may cause the user equipment at least to: in response to a cell change towards the second cell, derive a full configuration of the second cell based on the full configuration of the first cell and the first delta configuration information to connect to the second cell and subsequently, in response to a cell change towards the third cell, derive a full configuration of the third cell based on the full configuration of the second cell and the updated second delta configuration information to connect to the third cell. The instructions may cause the user equipment at least to: in response to a cell change towards one cell, derive a full configuration of that cell based on the full configuration of a current serving cell and the corresponding delta configuration information or the corresponding updated delta configuration information for the cell change to connect to that cell.

According to various, but not necessarily all, example embodiments of the invention there is provided a method for enabling subsequent cell change for a user equipment supporting connectivity towards a radio access network, the method comprising: establishing a connection between the user equipment and a first network node of the radio access network, the first network node supporting a first cell, deriving in the user equipment a full configuration of the first cell, receiving in the user equipment first delta configuration information related to a cell change from the first cell towards a second cell and second delta configuration information related to a cell change from the first cell towards a third cell, in response to a cell change towards the second cell, deriving a full configuration of the second cell based on the full configuration of the first cell and the first delta configuration information to connect to the second cell, and generating updated second delta configuration information for performing a cell change from the second cell towards the third cell, the generation of the updated second delta configuration information being based on the configuration information available to the user equipment prior to the cell change towards the second cell.

The generation of the updated second delta configuration information may be based on the full configuration of the first cell, the first delta configuration information and the second delta configuration information.

The generation of the updated second delta configuration information may be based on the full configuration of the first cell, the full configuration of the second cell and the second delta configuration information.

The generating may occur following the cell change from the first cell to the second cell.

The generating may occur between the cell change from the first cell to the second cell and a subsequent cell change.

The generating may identify differences between the first delta configuration information when applied to the full configuration of the first cell and the second delta configuration information when applied to the full configuration of the first cell and may incorporate those differences into the updated second delta configuration.

The generating may identify when an element or parameter has a different value in the second delta configuration information to a corresponding element or parameter in the first delta configuration information and may incorporate the different value from the second delta configuration information for the element or parameter into the updated second delta configuration information.

The generating may identify when an element or parameter in the first delta configuration information has no a corresponding element or parameter in the second delta configuration information and may incorporate a corresponding element or parameter from the full configuration of the first cell into the updated second delta configuration information.

The generating may identify when an element or parameter in the first delta configuration information has no a corresponding element or parameter in the full configuration of the first cell and may incorporate an indication into the updated second delta configuration information that the element or parameter should be removed.

The method may comprise, in response to a further cell change towards the third cell, deriving a full configuration of the third cell based on the full configuration of the second cell and the updated second delta configuration to connect to the third cell.

The method may comprise, repeating the generating of updated delta configuration information in response to the further cell change to the third cell.

The method may comprise, receiving the full configuration of the first cell, the first delta configuration information and/or the second delta configuration information using RRC signalling.

The first network node may comprise at least one of or supports functionality of at least one of: a base station, a 5G gNB, a Centralised Unit, a Distributed Unit, a secondary node, a source node or a source secondary node.

The user equipment may support dual connectivity to a master node and a secondary node.

The first cell may be at least one of a primary secondary cell or primary secondary cell supported by a source secondary node, or a source primary secondary cell, or a currently serving cell.

The second cell may be at least one of a primary secondary cell or primary secondary cell supported by a first target secondary node, or a target primary secondary cell, or a target serving cell.

The third cell may be at least one of a primary secondary cell or primary secondary cell supported by a second target secondary node, or a target primary secondary cell, or a target serving cell.

The method may comprise, receiving information related to a conditional cell PSCell change for moving from the first to the second cell and, if the condition for the cell PSCell change to the second cell holds, then performing random access to the second cell.

The method may comprise, when random access to the second cell is successful, storing the updated second delta configuration information and deleting the second delta configuration information.

The method may comprise, receiving information related to a conditional cell PSCell change for moving from the first to the third cell and, if the condition for the cell PSCell change to the third cell holds, then performing random access to the third cell.

The user equipment may be configured for subsequent selective activation.

The user equipment may be configured using at least one RRC reconfiguration message.

The method may comprise, receiving configuration information for performing L1 measurements.

The method may comprise, sending an L1 measurement report including second cell information towards the first cell or source network node and receiving a trigger to handover to the second cell.

The user equipment may be configured for dynamic switching.

According to various, but not necessarily all, example embodiments of the invention there is provided a non-transitory computer readable medium comprising program instructions stored thereon for performing at least the following: establishing a connection between the user equipment and a first network node of the radio access network, the first network node supporting a first cell, deriving in the user equipment a full configuration of the first cell, receiving in the user equipment first delta configuration information related to a cell change from the first cell towards a second cell and second delta configuration information related to a cell change from the first cell towards a third cell, in response to a cell change towards the second cell, deriving a full configuration of the second cell based on the full configuration of the first cell and the first delta configuration information to connect to the second cell, and generating updated second delta configuration information for performing a cell change from the second cell towards the third cell, the generation of the updated second delta configuration information being based on the configuration information available to the user equipment prior to the cell change towards the second cell.

The instructions may have and perform the optional features of the method set out above.

According to various, but not necessarily all, example embodiments of the invention there is provided a method for enabling subsequent cell change for a user equipment supporting connectivity towards a radio access network, the method comprising: establishing a connection between the user equipment and a first network node of the radio access network, the first network node supporting a first cell, deriving in the user equipment a full configuration of the first cell, receiving in the user equipment first delta configuration information related to a cell change from the first cell towards a second cell and second delta configuration information related to a cell change from the first cell towards a third cell, and further receiving in the user equipment updated second delta configuration information related to a cell change from the second cell towards the third cell prior to the cell change towards the second cell.

The method may comprise, in response to a cell change towards the second cell, deriving a full configuration of the second cell based on the full configuration of the first cell and the first delta configuration information to connect to the second cell.

The method may comprise, in response to a subsequent cell change towards the third cell, deriving a full configuration of the third cell based on the full configuration of the second cell and the updated second delta configuration information to connect to the third cell.

The method may comprise, receiving the full configuration of the first cell, the first delta configuration information, the second delta configuration information and/or the updated second delta configuration information using RRC signalling.

The first delta configuration information, the second delta configuration information and/or the updated second delta configuration information may be received within a single RRC message.

The first delta configuration information, the second delta configuration information and/or the updated second delta configuration information may be received within a nested RRC message.

Updated second delta configuration information may be received while being connected to the first cell and before determining to perform a cell change.

The method may comprise, further receiving a fourth delta configuration information related to a cell change from the second cell towards the first cell.

The method may comprise, in response to a cell change towards the second cell, deriving a full configuration of the second cell based on the full configuration of the first cell and the first delta configuration information to connect to the second cell and subsequently, in response to a cell change towards the third cell, deriving a full configuration of the third cell based on the full configuration of the second cell and the updated second delta configuration information to connect to the third cell.

The method may comprise, in response to a cell change towards one cell, deriving a full configuration of that cell based on the full configuration of a current serving cell and the corresponding delta configuration information or the corresponding updated delta configuration information for the cell change to connect to that cell.

According to various, but not necessarily all, example embodiments of the invention there is provided a non-transitory computer readable medium comprising program instructions stored thereon for performing at least the following: establishing a connection between the user equipment and a first network node of the radio access network, the first network node supporting a first cell, deriving in the user equipment a full configuration of the first cell, receiving in the user equipment first delta configuration information related to a cell change from the first cell towards a second cell and second delta configuration information related to a cell change from the first cell towards a third cell, and further receiving in the user equipment updated second delta configuration information related to a cell change from the second cell towards the third cell prior to the cell change towards the second cell.

The instructions may have and perform the optional features of the method set out above.

According to various, but not necessarily all, example embodiments of the invention there is provided a first network node of a telecommunications network comprising: at least one processor; and at least one memory storing instructions that, when executed by the at least one processor, cause the user equipment at least to: receive, in the first network node, first delta configuration information related to a cell change from a first cell towards a second cell and second delta configuration information related to a cell change from the first cell towards a third cell, and generating updated second delta configuration information for performing a cell change from the second cell towards the third cell, the generation of the updated second delta configuration information being based on the configuration information available to the first network node prior to the cell change towards the second cell.

The instructions may cause the first network node at least to: generate updated first delta configuration information for performing a cell change from the third cell towards the second cell, the generation of the updated second delta configuration information being based on the configuration information available to the first network node prior to the cell change towards the second cell.

The generation of the updated second delta configuration information and/or the updated first delta configuration information may be based on the full configuration of the first cell, the first delta configuration information and the second delta configuration information.

The generation of the updated second delta configuration information may be based on the full configuration of the first cell, a full configuration of the second cell and the second delta configuration information.

The generation of the updated first delta configuration information may be based on the full configuration of the first cell, a full configuration of the third cell and the first delta configuration information.

The generating may occur prior to the cell change from the first cell to the second cell or the third cell.

The generating may identify differences between the first delta configuration information when applied to the full configuration of the first cell and the second delta configuration information when applied to the full configuration of the first cell and may incorporate those differences into the updated second delta configuration and/or the updated second delta configuration information.

The generating may identify when an element or parameter has a different value in the second delta configuration information to a corresponding element or parameter in the first delta configuration information and may incorporate the different value from the second delta configuration information for the element or parameter into the updated second delta configuration information.

The generating may identify when an element or parameter in the first delta configuration information has no a corresponding element or parameter in the second delta configuration information and may incorporate a corresponding element or parameter from the full configuration of the first cell into the updated second delta configuration information.

The generating may identify when an element or parameter in the first delta configuration information has no a corresponding element or parameter in the full configuration of the first cell and may incorporate an indication into the updated second delta configuration information that the element or parameter should be removed.

The generating may identify when an element or parameter has a different value in the first delta configuration information to a corresponding element or parameter in the second delta configuration information and may incorporate the different value from the first delta configuration information for the element or parameter into the updated first delta configuration information.

The generating may identify when an element or parameter in the second delta configuration information has no a corresponding element or parameter in the first delta configuration information and may incorporate a corresponding element or parameter from the full configuration of the second cell into the updated first delta configuration information.

The generating may identify when an element or parameter in the second delta configuration information has no a corresponding element or parameter in the full configuration of the second cell and may incorporate an indication into the updated first delta configuration information that the element or parameter should be removed.

The first delta configuration information and/or the first delta configuration information may be received using SN Addition Request Acknowledgement or Handover Request Acknowledgement messaging.

The first network node may comprise at least one of or supports functionality of at least one of: is a base station, a 5G gNB, a Centralised Unit, a Distributed Unit, a secondary node, a source node or a source secondary node.

The user equipment may support dual connectivity to a master node and a secondary node.

The first cell may be at least one of a primary secondary cell or primary secondary cell supported by a source secondary node, or a source primary secondary cell, or a currently serving cell.

The second cell may be at least one of a primary secondary cell or primary secondary cell supported by a first target secondary node, or a target primary secondary cell, or a target serving cell.

The third cell may be at least one of a primary secondary cell or primary secondary cell supported by a second target secondary node, or a target primary secondary cell, or a target serving cell.

The instructions may cause the user equipment at least to: transmit the full configuration of the first cell, the first delta configuration information, the updated first delta configuration information, the second delta configuration information and/or the updated second delta configuration information using RRC signalling.

The full configuration of the first cell, the first delta configuration information, the updated first delta configuration information, the second delta configuration information and/or the updated second delta configuration information may be received within a single RRC message.

The full configuration of the first cell, the first delta configuration information, the updated first delta configuration information, the second delta configuration information and/or the updated second delta configuration information may be received within a nested RRC message.

According to various, but not necessarily all, example embodiments of the invention there is provided a method for enabling cell change for a user equipment supporting connectivity towards a radio access network, the method comprising: receiving, in a first network node, first delta configuration information related to a cell change from a first cell towards a second cell and second delta configuration information related to a cell change from the first cell towards a third cell, and generating updated second delta configuration information for performing a cell change from the second cell towards the third cell, the generation of the updated second delta configuration information being based on the configuration information available to the first network node prior to the cell change towards the second cell.

The method may further comprise generating updated first delta configuration information for performing a cell change from the third cell towards the second cell, the generation of the updated second delta configuration information being based on the configuration information available to the first network node prior to the cell change towards the second cell.

The generation of the updated second delta configuration information and/or the updated first delta configuration information may be based on the full configuration of the first cell, the first delta configuration information and the second delta configuration information.

The generation of the updated second delta configuration information may be based on the full configuration of the first cell, a full configuration of the second cell and the second delta configuration information.

The generation of the updated first delta configuration information, may be based on the full configuration of the first cell, a full configuration of the third cell and the first delta configuration information.

The generating may occur prior to the cell change from the first cell to the second cell or the third cell.

The generating may identify differences between the first delta configuration information when applied to the full configuration of the first cell and the second delta configuration information when applied to the full configuration of the first cell and may incorporate those differences into the updated second delta configuration and/or the updated second delta configuration information.

The generating may identify when an element or parameter has a different value in the second delta configuration information to a corresponding element or parameter in the first delta configuration information and may incorporate the different value from the second delta configuration information for the element or parameter into the updated second delta configuration information.

The generating may identify when an element or parameter in the first delta configuration information has no a corresponding element or parameter in the second delta configuration information and may incorporate a corresponding element or parameter from the full configuration of the first cell into the updated second delta configuration information.

The generating may identify when an element or parameter in the first delta configuration information has no a corresponding element or parameter in the full configuration of the first cell and may incorporate an indication into the updated second delta configuration information that the element or parameter should be removed.

The generating may identify when an element or parameter has a different value in the first delta configuration information to a corresponding element or parameter in the second delta configuration information and may incorporate the different value from the first delta configuration information for the element or parameter into the updated first delta configuration information.

The generating may identify when an element or parameter in the second delta configuration information has no a corresponding element or parameter in the first delta configuration information and may incorporate a corresponding element or parameter from the full configuration of the second cell into the updated first delta configuration information.

The generating may identify when an element or parameter in the second delta configuration information has no a corresponding element or parameter in the full configuration of the second cell and may incorporate an indication into the updated first delta configuration information that the element or parameter should be removed.

The first delta configuration information and/or the first delta configuration information may be received using SN Addition Request Acknowledgement or Handover Request Acknowledgement messaging.

The first network node may comprise at least one of or supports functionality of at least one of: is a base station, a 5G gNB, a Centralised Unit, a Distributed Unit, a secondary node, a source node or a source secondary node.

The user equipment may support dual connectivity to a master node and a secondary node.

The first cell may be at least one of a primary secondary cell or primary secondary cell supported by a source secondary node, or a source primary secondary cell, or a currently serving cell.

The second cell may be at least one of a primary secondary cell or primary secondary cell supported by a first target secondary node, or a target primary secondary cell, or a target serving cell.

The third cell may be at least one of a primary secondary cell or primary secondary cell supported by a second target secondary node, or a target primary secondary cell, or a target serving cell.

The method may comprise transmitting the full configuration of the first cell, the first delta configuration information, the updated first delta configuration information, the second delta configuration information and/or the updated second delta configuration information using RRC signalling.

The full configuration of the first cell, the first delta configuration information, the updated first delta configuration information, the second delta configuration information and/or the updated second delta configuration information may be received within a single RRC message.

The full configuration of the first cell, the first delta configuration information, the updated first delta configuration information, the second delta configuration information and/or the updated second delta configuration information may be received within a nested RRC message.

According to various, but not necessarily all, example embodiments of the invention there is provided a non-transitory computer readable medium comprising program instructions stored thereon for performing at least the following: receiving, in a first network node, first delta configuration information related to a cell change from a first cell towards a second cell and second delta configuration information related to a cell change from the first cell towards a third cell, and generating updated second delta configuration information for performing a cell change from the second cell towards the third cell, the generation of the updated second delta configuration information being based on the configuration information available to the first network node prior to the cell change towards the second cell.

The instructions may have and perform the optional features of the method set out above.

Further particular and preferred aspects are set out in the accompanying independent and dependent claims. Features of the dependent claims may be combined with features of the independent claims as appropriate, and in combinations other than those explicitly set out in the claims.

Where an apparatus feature is described providing a function, it will be appreciated that this includes an apparatus feature which provides that function or which is adapted or configured to provide that function.

### BRIEF DESCRIPTION

Some example embodiments will now be described with reference to the accompanying drawings in which:

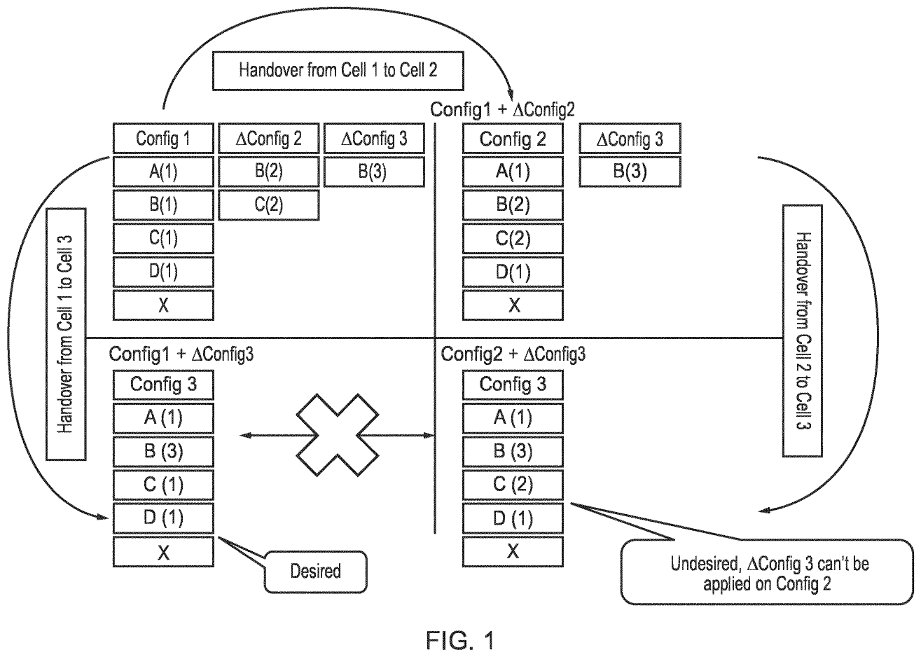

FIG. 1 illustrates a configuration mismatch after a cell change;

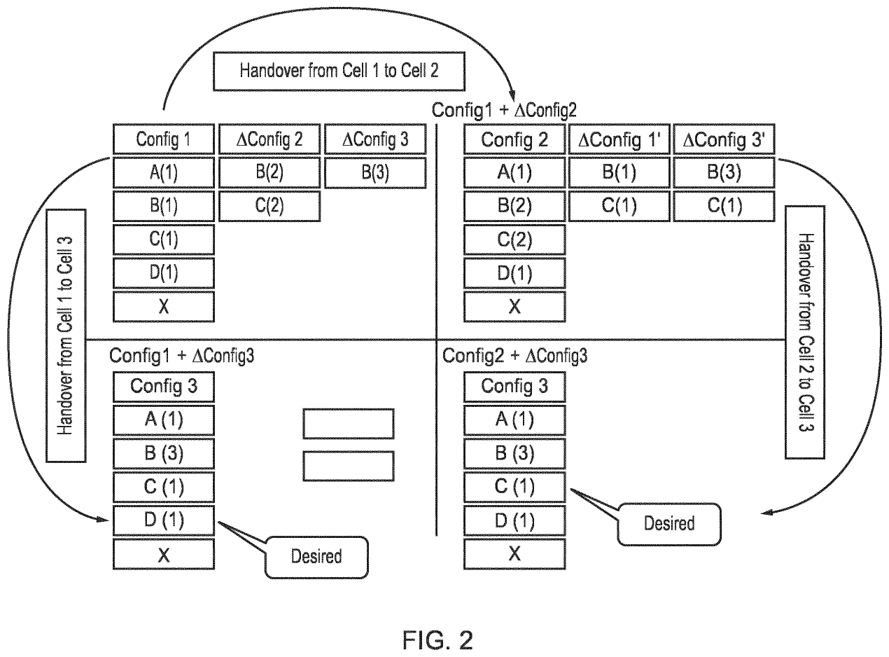

FIG. 2 illustrates how a newly generated delta configuration (i.e. ΔConfig 3′) can be applied on the current serving cell configuration (i.e. Config2) to enable further cell change;

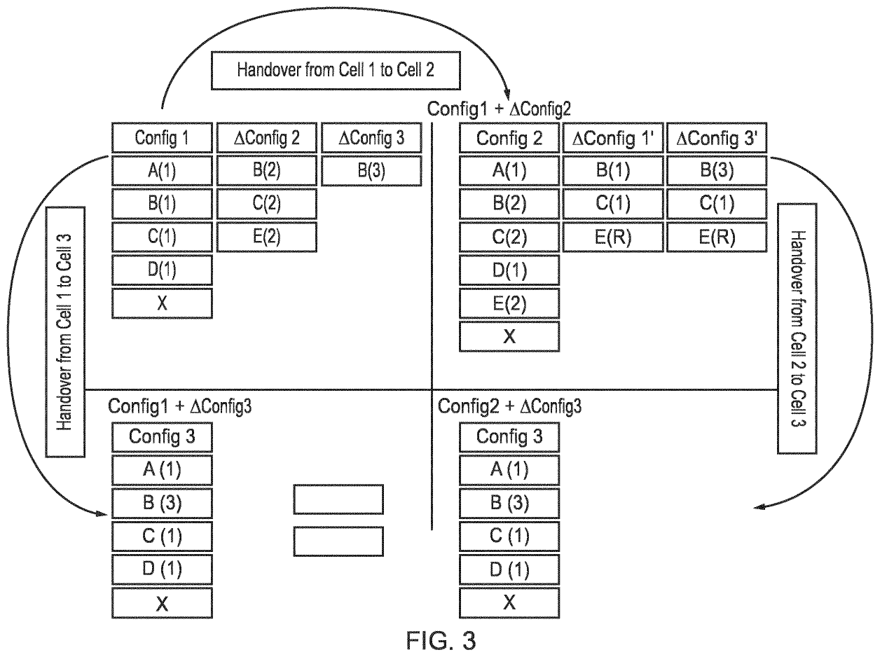

FIG. 3 also illustrates how a newly generated delta configuration (i.e. ΔConfig 3′) can be applied on the current serving cell configuration (i.e. Config2) to enable further cell change;

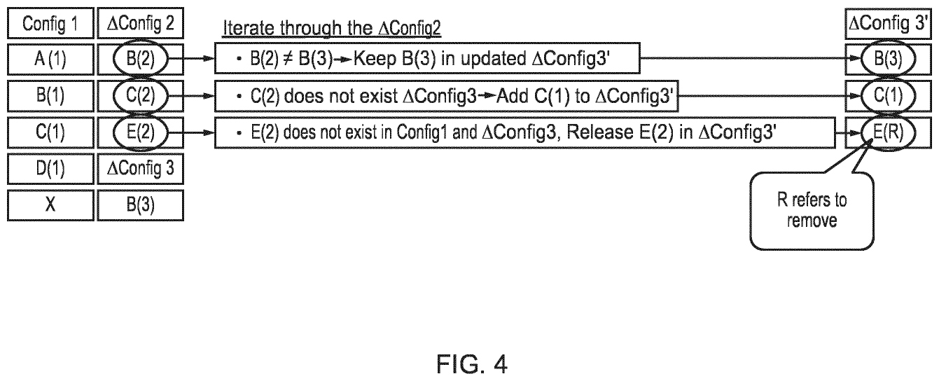

FIG. 4 illustrates an example implementation procedure to generate updated delta configuration (ΔConfig 3′) which can be applied over the current serving cell configuration (Config 2) to enable a change from Cell 2 to Cell 3;

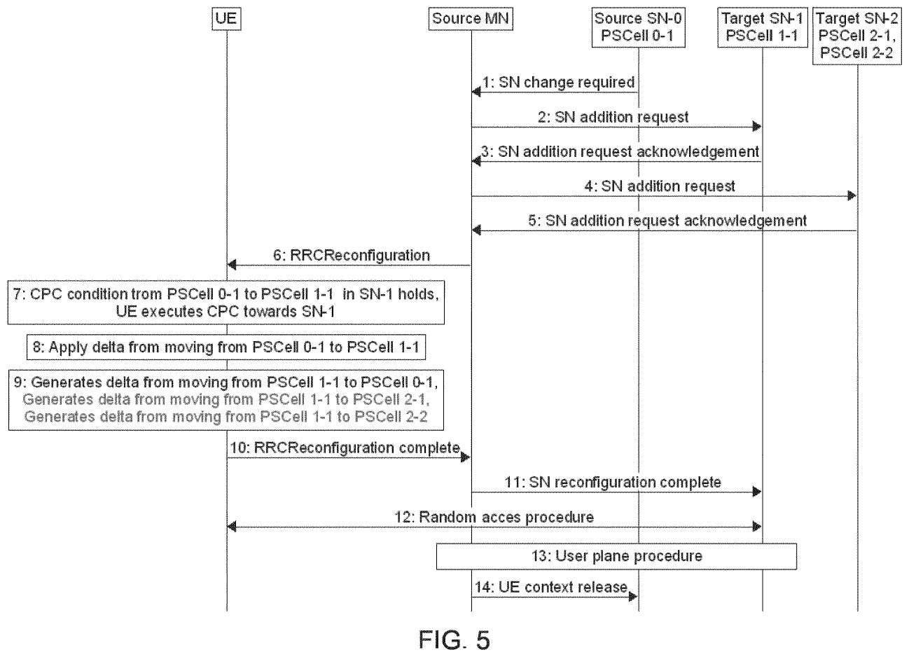

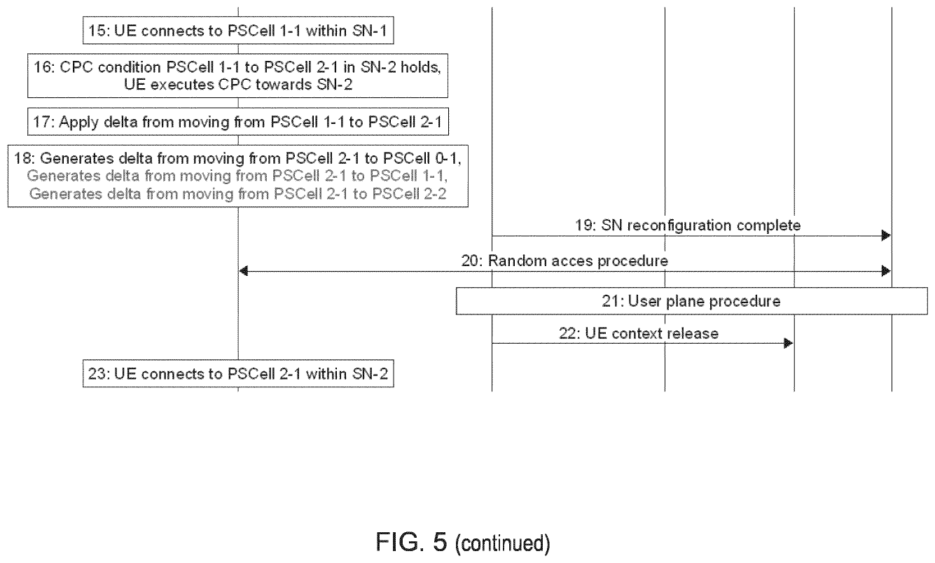

FIG. 5 illustrates an example operation of user equipment and network nodes, together with messaging during selective activation;

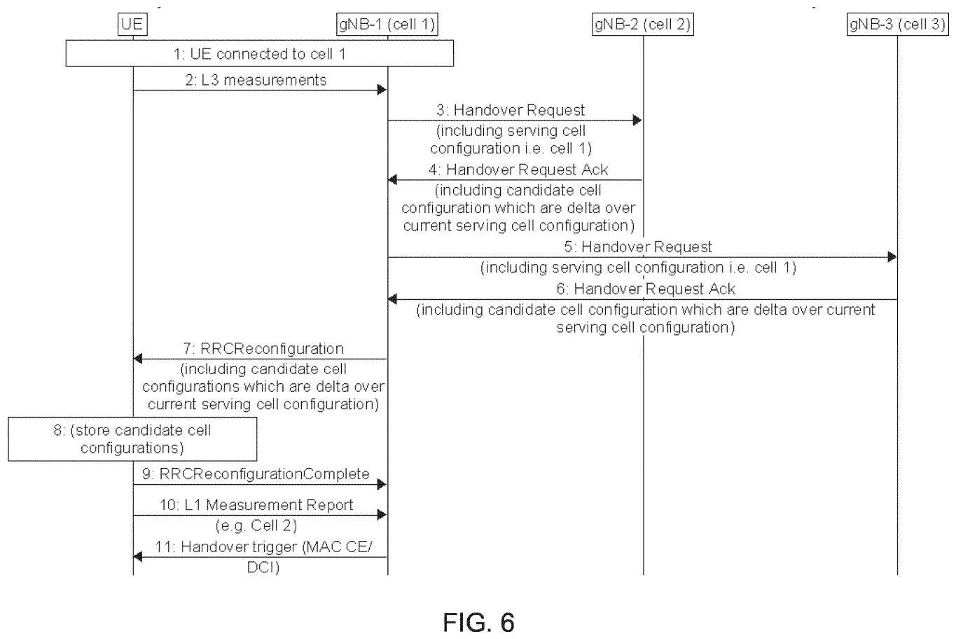

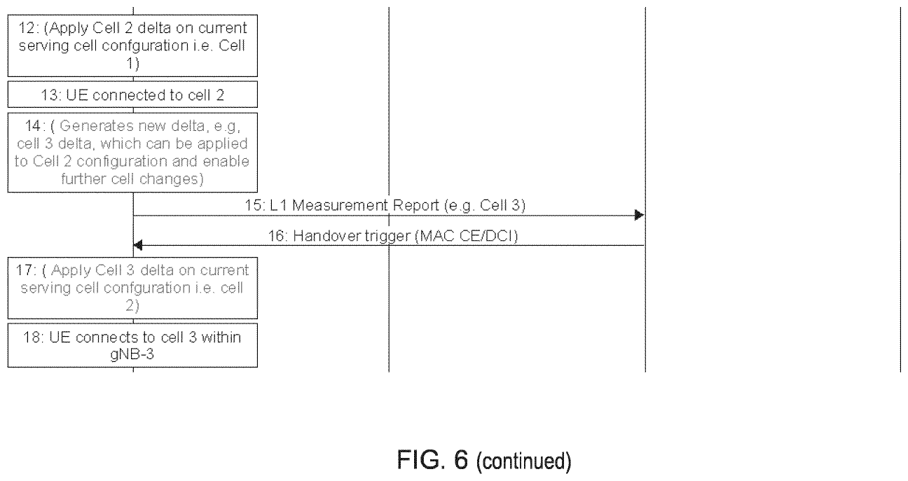

FIG. 6 illustrates an example operation of user equipment and network nodes, together with messaging for Lower-layer triggered mobility (LTM) and only inter-gNB scenario is shown;

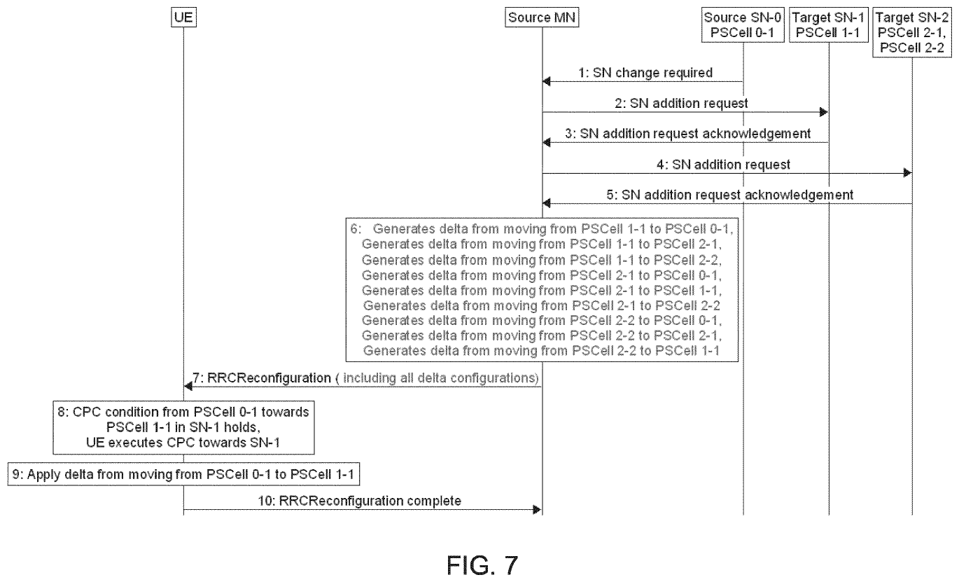

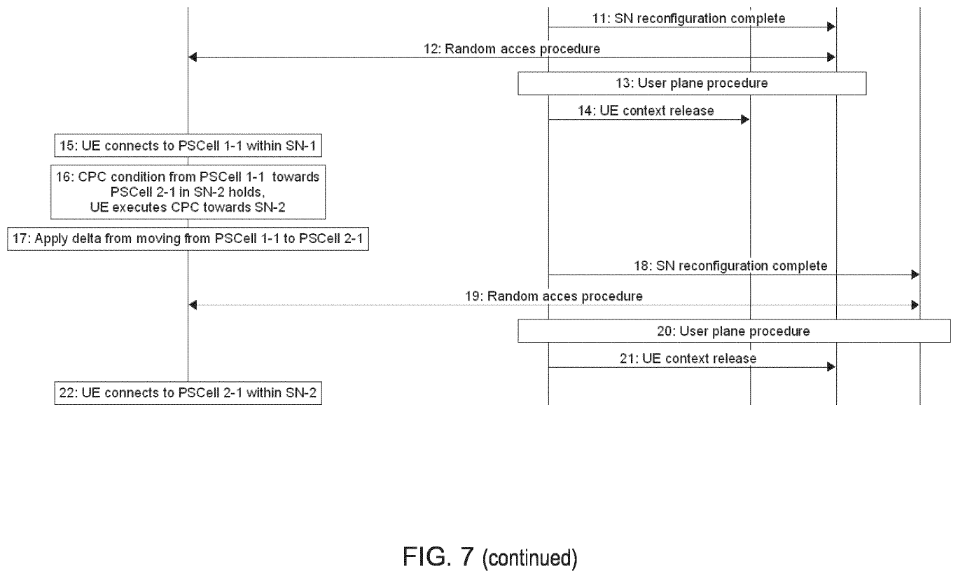

FIG. 7 illustrates an example operation of user equipment and network nodes, together with messaging for selective activation;

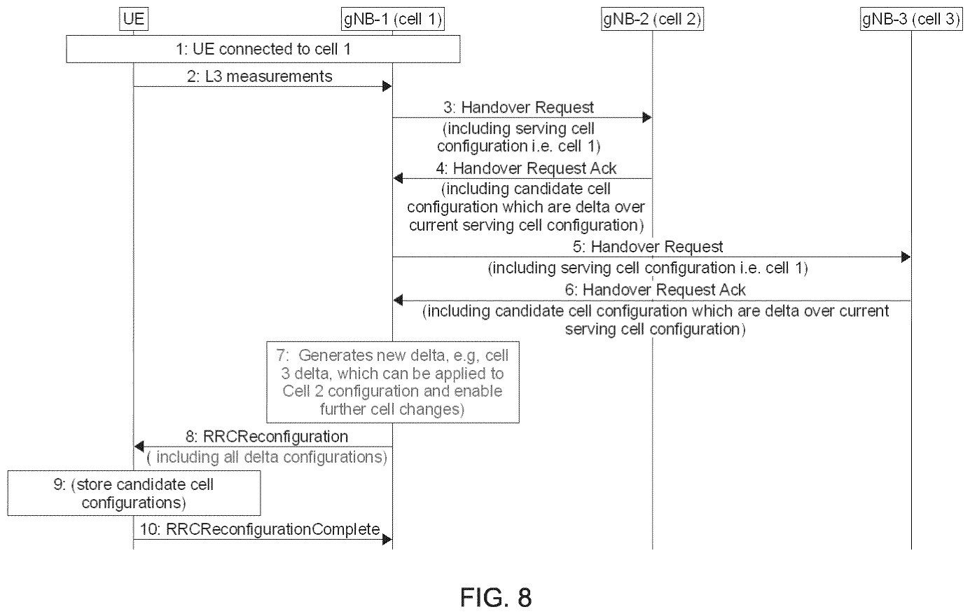

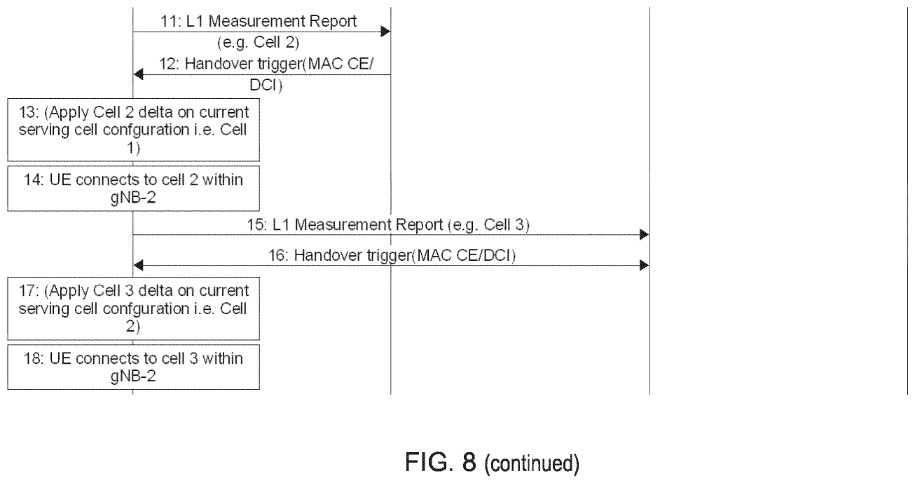

FIG. 8 illustrates an example operation of user equipment and network nodes, together with messaging for LTM and only inter-gNB scenario is shown;

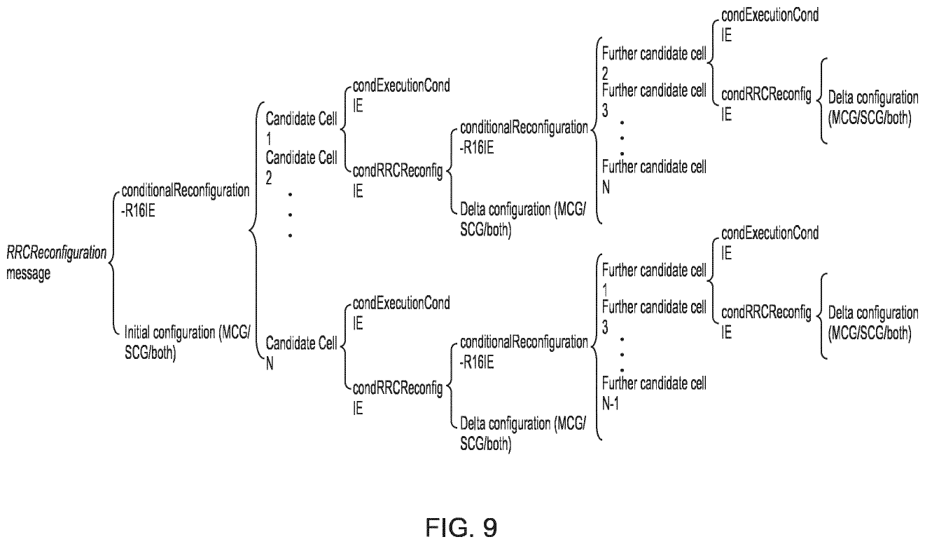

FIG. 9 illustrates a Radio Resource Configuration (RRC) model to send newly generated deltas to the UE (step 7 in FIG. 7 and step 8 in FIG. 8);

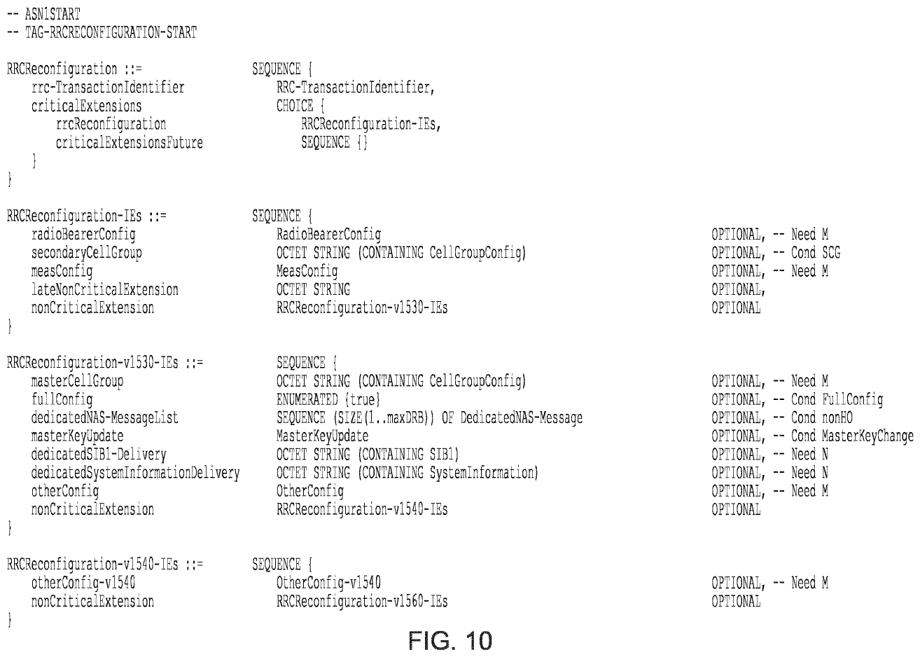

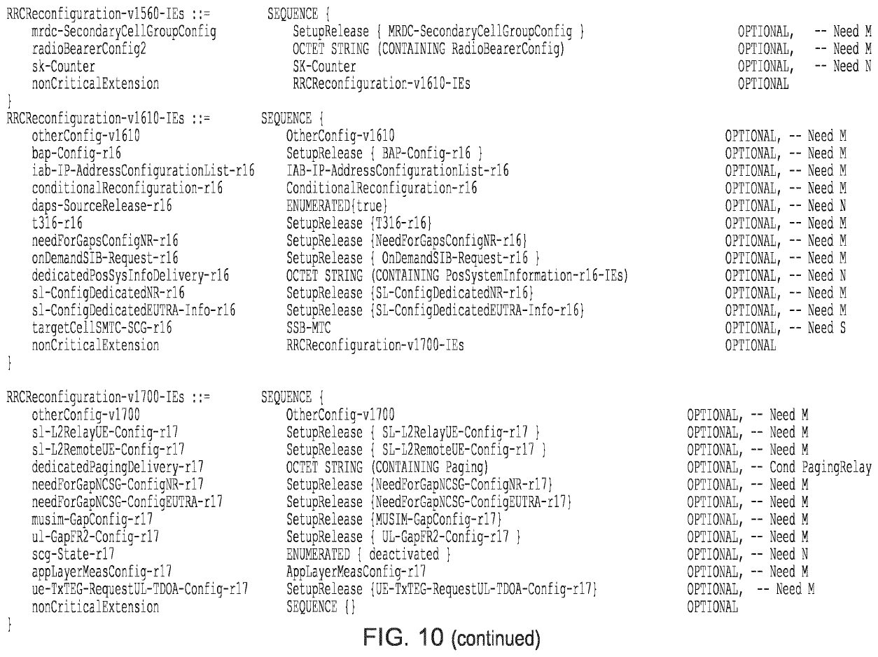

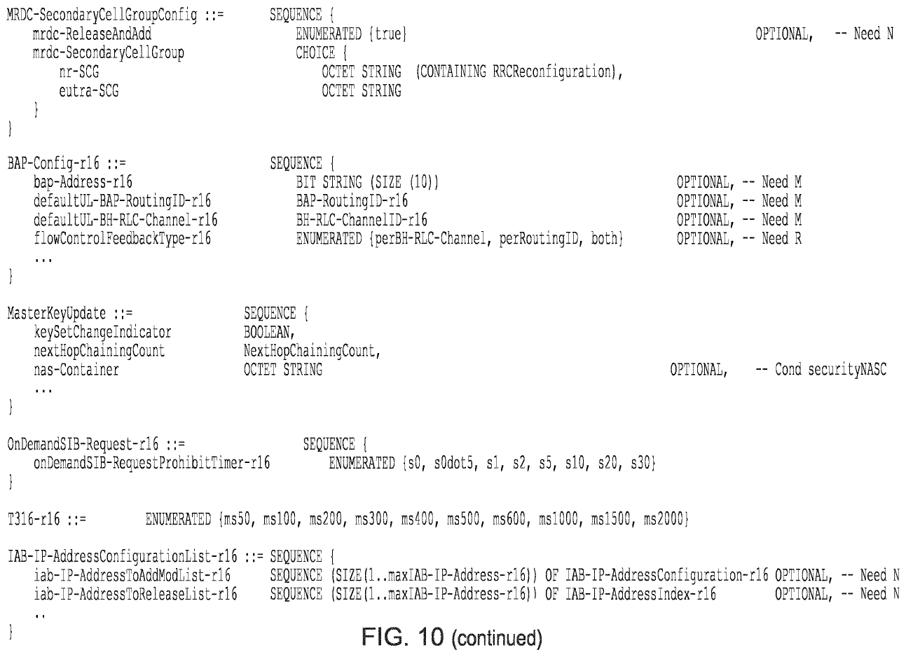

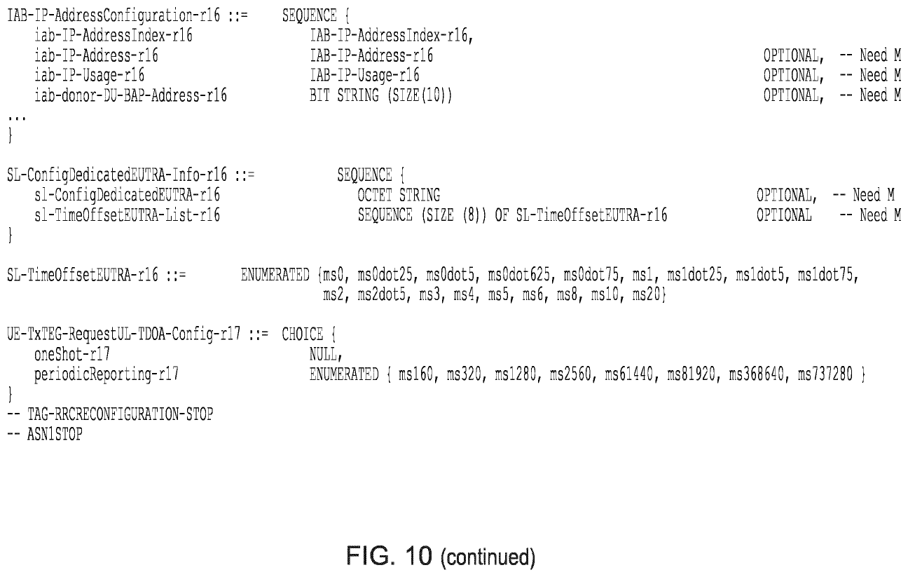

FIG. 10 illustrates RRC messages to which delta signalling is applied; and

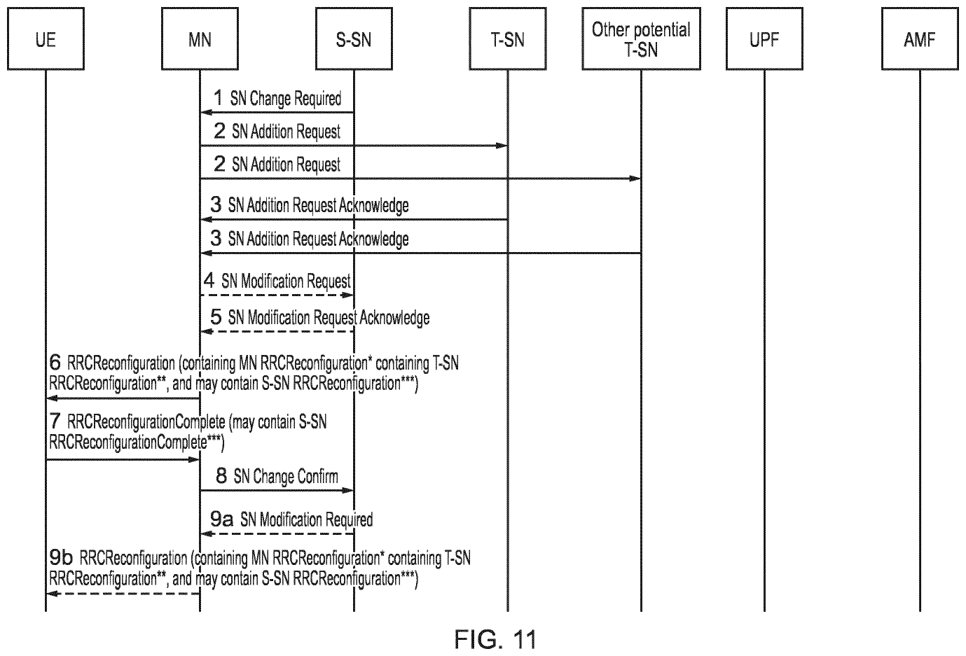

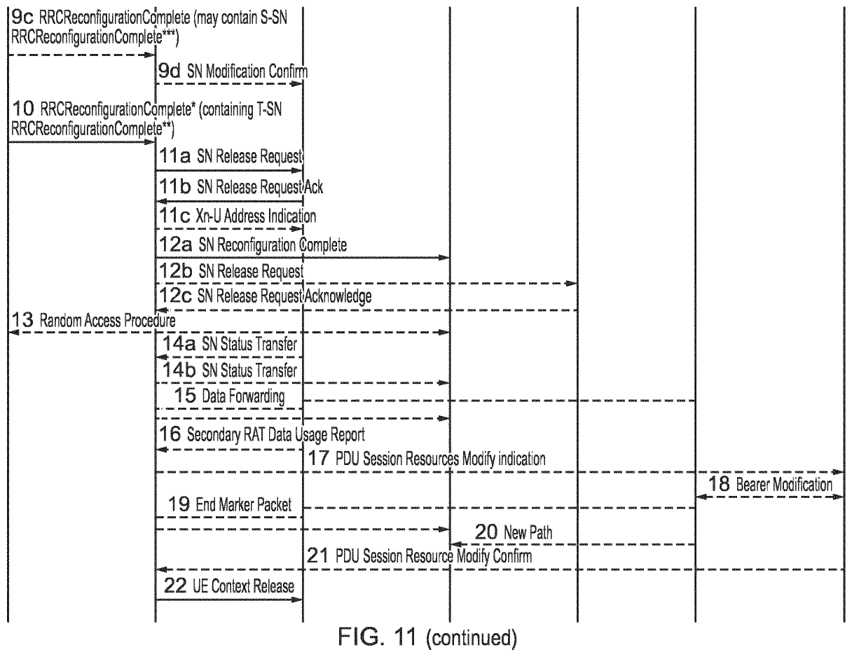

FIG. 11 illustrates an example signalling flow for conditional Secondary Node (SN) Change initiated by the SN.

### DETAILED DESCRIPTION

Before discussing the example embodiments in any more detail, first an overview will be provided. Some example embodiments relate to cell change in a wireless telecommunications network. A user equipment may connect typically to a first or source cell. One or more target cells are provided to which the user equipment may connect in a cell change from the first cell. The user equipment is provided with delta configurations for the target cells. Those delta configurations can be applied to the configuration currently being used for the first cell to enable the user equipment to connect to the target cells. Additional, updated delta configurations are typically provided. Those updated delta configurations can then be applied following a cell change from the first cell to a target cell to enable the user equipment to connect to another cell (which could be any other target cell or even the first cell) following that cell change. The updated delta configurations are typically retained together with associated delta configurations, with the associated delta configurations only being overwritten when no longer required. Those updated delta configurations can be provided either by the user equipment itself which generates them from the configuration information and the delta configurations or by the network which generates them from the configuration information and the delta configurations and transmits them to the user equipment. When provided by the network, different updated delta configurations can be provided for different combinations of source and target cells. This approach enables user equipment to rapidly change from cell to cell without needing to receive updated delta configurations each time from the network.

### Delta Configuration—Overview

Some example embodiments provide general enhancement when making use of delta configurations. In an example delta-configuration approach, for the user equipment (UE), the configuration parameters for its radio interface operation are provided via a Radio Resource Configuration (RRC)-Reconfiguration message in a wireless telecommunications network such as 3GPP-based network (currently deployed in LTE and 5G Networks, and beyond) and/or other networks. The configuration parameters provided from the network (NW) are marked or indicated to be stored until new value(s) are received from the network. These parameters are marked as ‘Need M’ in the signaling message. During mobility, the target cell configuration is provided to the UE which only gives the parameters which are to be changed. For all other parameters, the UE continue to use the existing values. The new parameters, which are provided as part of cell-change, are called a ‘delta-configuration’. The delta-configuration is used by the network for cell change to minimize the configuration change during mobility. Only in case of issues in modifying existing parameters, the network provides a full-configuration containing all the parameters once-again.

In RRC messages, one example where delta signalling is applied is the RRCReconfiguration message as described in Section 6.2.2. in TS 38.331, details of which are illustrated in FIG. 10. As mentioned above, some of the information elements (IE) for the parameters are Need M. Need M means that the UE maintains the value of the IE (this is explained in Section 6.1.2 in TS 38.331). In short, delta signalling can be provided on radioBearerConfig, CellGroupConfig, measConfig, etc as explained in more detail below.

### 3GPP TS 38.331 v17.2.0 (2022-09)

### 11.2 Inter-Node RRC Messages

### 11.2.2 Message Definitions

### -CG-Config

This message is used to transfer the SCG radio configuration as generated by the SgNB or SeNB. It can also be used by a CU to request a DU to perform certain actions, e.g. to request the DU to perform a new lower layer configuration.

Direction: Secondary gNB or eNB to master gNB or eNB, alternatively CU to DU.

scg-CellGroupConfig

Contains the RRCReconfiguration message (containing only secondaryCellGroup and/or measConfig and/or otherConfig and/or conditionalReconfiguration and/or bap-Config and/or iab-IP-AddressConfigurationList):
to be sent to the UE, used upon SCG establishment or modification (only when the SCG is not released by the SN), as generated (entirely) by the (target) SgNB. In this case, the SN sets the RRCReconfiguration message in accordance with clause 6 e.g. regarding the “Need” or “Cond” statements.
or
including the current SCG configuration of the UE, when provided in response to a query from MN, or in SN triggered SN change in order to enable delta signaling by the target SN. In this case, the SN sets the RRCReconfiguration message in accordance with clause 11.2.3.

The field is absent if neither SCG (re)configuration nor SCG configuration query nor SN triggered SN change is performed, e.g. at inter-node capability/configuration coordination which does not result in SCG (re)configuration towards the UE. The field is also absent upon an SCG release triggered by the SN. This field is not applicable in NE-DC.

scg-CellGroupConfigEUTRA

Includes the E-UTRA RRCConnectionReconfiguration message as specified in TS 36.331 [10]. In this version of the specification, the E-UTRA RRC message can only include the field scg-Configuration:
to be sent to the UE, used to (re-)configure the SCG configuration upon SCG establishment or modification (only when the SCG is not released by the SN), as generated (entirely) by the (target) SeNB. In this case, the SN sets the scg-Configuration within the EUTRA RRCConnectionReconfiguration message in accordance with clause 6 in TS 36.331 [10] e.g. regarding the “Need” or “Cond” statements.
or
including the current SCG configuration of the UE, when provided in response to a query from MN, or in SN triggered SN change in order to enable delta signalling by the target SN.

The field is absent if neither SCG (re)configuration nor SCG configuration query nor SN triggered SN change is performed, e.g. at inter-node capability/configuration coordination which does not result in SCG (re)configuration towards the UE. The field is also absent upon an SCG release triggered by the SN. This field is only used in NE-DC.

scg-RB-Config

Contains the IE RadioBearerConfig:
to be sent to the UE, used to (re-)configure the SCG RB configuration upon SCG establishment or modification, as generated (entirely) by the (target) SgNB or SeNB. In this case, the SN sets the RadioBearerConfig in accordance with clause 6, e.g. regarding the “Need” or “Cond” statements.
or
including the current SCG RB configuration of the UE, when provided in response to a query from MN or in SN triggered SN change or in SN triggered SN release or bearer type change between SN terminated bearer to MN terminated bearer in order to enable delta signaling by the MN or target SN. In this case, the SN sets the RadioBearerConfig in accordance with clause 11.2.3.

The field is absent if neither SCG (re)configuration nor SCG configuration query nor SN triggered SN change nor SN triggered SN release is performed, e.g. at inter-node capability/configuration coordination which does not result in SCG RB (re)configuration.

### -CG-ConfigInfo

This message is used by master eNB or gNB to request the SgNB or SeNB to perform certain actions e.g. to establish, modify or release an SCG. The message may include additional information e.g. to assist the SgNB or SeNB to set the SCG configuration. It can also be used by a CU to request a DU to perform certain actions, e.g. to establish, or modify an MCG or SCG.

Direction: Master eNB or gNB to secondary gNB or eNB, alternatively CU to DU.

mcg-RB-Config

Contains all of the fields in the IE RadioBearerConfig used in MN, used by the SN to support delta configuration to UE (i.e. when MN does not use full configuration option), for bearer type change between MN terminated bearer with NR PDCP to SN terminated bearer. It is also used to indicate the PDCP duplication related information for MN terminated split bearer (whether duplication is configured and if so, whether it is initially activated) in SN Addition/Modification procedure. Otherwise, this field is absent.

scg-RB-Config

Contains all of the fields in the IE RadioBearerConfig used in SN, used to allow the target SN to use delta configuration to the UE, e.g. during SN change. The field is signalled upon change of SN unless MN uses full configuration option. Otherwise, the field is absent.

sourceConfigSCG

Includes all of the current SCG configurations used by the target SN to build delta configuration to be sent to UE, e.g. during SN change. The field contains the RRCReconfiguration message, i.e. including secondaryCellGroup and measConfig. The field is signalled upon change of SN, unless MN uses full configuration option. Otherwise, the field is absent.

### 3GPP TS 37.340 v17.2.0 (2022-09)

### 10.5 Secondary Node Change (MN/SN Initiated)

10.5.2 MR-DC with 5GC

### SN Initiated Conditional SN Change

The SN initiated conditional SN change procedure is used for CPC configuration and CPC execution.

The SN initiated conditional SN change procedure may also be initiated by the source SN, to modify the existing CPC configuration, or to trigger the release of the candidate SN by cancellation of all the prepared PSCells at the candidate SN and releasing the CPC related UE context at the candidate SN.

FIG. 11 shows an example signalling flow for the conditional SN change initiated by the SN:

1. The source SN initiates the conditional SN change procedure by sending the SN Change Required message, which contains a CPC initiation indication. The message also contains candidate node ID(s) and may include the SCG configuration (to support delta configuration), and contains the measurements results which may include cells that are not CPC candidates. The message also includes a list of proposed PSCell candidates recommended by the source SN, including execution conditions, the upper limit for the number of PSCells that can be prepared by each candidate SN, and may also include the SCG measurement configurations for CPC (e.g. measurement ID(s) to be used for CPC).

2/3. The MN requests each candidate SN(s) to allocate resources for the UE by means of the SN Addition procedure(s), indicating the request is for CPAC, and the measurements results which may include cells that are not CPC candidates received from the source SN to the candidate SN, and indicating a list of proposed PSCell candidates received from the source SN, but not including execution conditions. Within the list of PSCells suggested by the source SN, the candidate SN decides the list of PSCell(s) to prepare (considering the maximum number indicated by the MN) and, for each prepared PSCell, the candidate SN decides SCG SCells and provides the new corresponding SCG radio resource configuration to the MN in an NR RRCReconfiguration** message contained in the SgNB Addition Request Acknowledge message. If data forwarding is needed, the candidate SN provides data forwarding addresses to the MN. The candidate SN includes the indication of full or delta RRC configuration, and the list of prepared PSCell IDs to the MN. The candidate SN can either accept or reject each of the candidate cells suggested by the source SN, i.e., it cannot configure any alternative candidates.

6. The MN sends to the UE an RRCReconfiguration message including the CPC configuration, i.e. a list of RRCReconfiguration* messages and associated execution conditions, in which each RRCReconfiguration* message contains the SCG configuration in the RRCReconfiguration** message received from the candidate SN in step 3 and possibly an MCG configuration. Besides, the RRCReconfiguration message can also include an updated MCG configuration, as well as the NR RRCReconfiguration*** message generated by the source SN, e.g., to configure the required conditional measurements.

7. The UE applies the RRCReconfiguration message received in step 6, stores the CPC configuration and replies to the MN with an RRCReconfigurationComplete message, which can include an NR RRCReconfigurationComplete*** message. In case the UE is unable to comply with (part of) the configuration included in the RRCReconfiguration message, it performs the reconfiguration failure procedure.

10. The UE starts evaluating the execution conditions. If the execution condition of one candidate PSCell is satisfied, the UE applies RRCReconfiguration* message corresponding to the selected candidate PSCell, and sends an RRCReconfigurationComplete* message, including an RRCReconfigurationComplete** message for the selected candidate PSCell, and information enabling the MN to identify the SN of the selected candidate PSCell.

11a-11c. The MN triggers the MN initiated SN Release procedure to inform the source SN to stop providing user data to the UE, and triggers the Xn-U Address Indication procedure to inform the source SN the address of the SN of the selected candidate PSCell and if applicable, starts late data forwarding.

12a-12c. If the RRC connection reconfiguration procedure was successful, the MN informs the SN of the selected candidate PSCell via SN Reconfiguration Complete message, including the SN RRCReconfigurationComplete** message. The MN sends the SN Release Request message(s) to cancel CPC in the other candidate SN(s), if configured. The other candidate SN(s) acknowledges the release request.

13. The UE synchronizes to the PSCell indicated in the RRCReconfiguration* message applied in step 10.

In case of implementing a network with subsequent or consecutive selective activation possibilities like e.g. in FIG. 5, the above steps 12b and 12c might not be performed in order not to cancel configured CPC for other candidate SN(s).

Key Requirements of selective activation and dynamic switching in L1/L2 based inter-cell mobility (also known as Lower-layer triggered mobility (LTM)) objectives are: Storage of multiple cell-group configs at UE (or target cell configurations); The configuration change should be done with minimum interruption and preferably without or minimum additional reconfiguration; Selection of the cell group based on radio conditions or other criteria. Conditional activation of the cell group using Rel. 17 or based on L1 measurements in L1/L2 based inter-cell mobility (LTM). Furthermore, it has been agreed in 3GPP that delta signalling will be supported in Rel. 18, both for selective activation and dynamic switching in LTM. The relevant agreements from RAN2#119bis are:—3GPP agreement for Selective Activation: Confirm that we aim to support delta configuration, i.e. that there need to be a known reference. 3GPP agreement for LTM: For L1/L2 mobility will support that candidate configurations are delta configurations on top of a reference configuration. For future study if the reference configuration is a separate reference configuration or e.g. the current configuration.

### Delta Configuration—Current Approach

One scenario for selective activation or dynamic switching in LTM is configuration of a UE for Conditional PSCell Addition/Change (CPAC)/LTM as starting point and ensuring a survival of the CPAC/LTM related configurations after the initial cell change execution. This scenario, the candidate target cell configurations provided to the UE as part of CPAC/LTM configurations can be delta configurations over current serving (Secondary Cell Group) SCG configuration, i.e., configuration is defined relative to the current serving cell configuration. After execution of CPAC/LTM to one target-cell, the serving cell configuration is changed to new cell configuration. The stored CPAC/LTM configurations which are ‘delta’ configurations relative to the previous serving cell configuration cannot be used as such for further CPAC/LTM execution. Therefore, the previously provided configurations (i.e. CPAC/LTM configurations) after initial execution will not work without resolving the above issue because they were delta configurations compared to the previous serving cell configuration and not delta configurations compared to the current (new) serving cell configuration. This is illustrated in more detail in FIG. 1. As shown, the UE is initially being served by cell 1 and stores the full configuration for serving cell 1 (Config 1). The UE is provided with delta configurations for target cells 2 and 3 (ΔConfig 2, ΔConfig 3, i.e. just the changes that would need to be made to the configuration for serving cell 1 (Config 1) to instead be served by cells 2 or 3). When the UE moves from current serving cell 1 to target serving cell 2, it applies the delta configuration for target cell 2 (ΔConfig 2) to the configuration for current serving cell 1 (Config 1) and stores the full configuration for serving cell 2 (Config 2—in this case replacing B(1) with B(2) and replacing C(1) with C(2)). However, when the UE then moves from current serving cell 2 to target cell 3, it has the current serving cell configuration as Config 2 and applying ΔConfig 3 over Config 2 will lead to undesired/wrong configuration, resulting in configuration mismatch on the UE and network side (C(2) should be C(1) but was changed to C(2) when the delta configuration for target cell 2 (ΔConfig 2) was applied). This is because, ΔConfig 3 is the delta configuration provided to the UE by the network with respect to the Config 1 (the initial serving cell configuration at the time of the preparation phase when the delta configurations were provided), rather than being the delta configuration with respect to Config 2.

### Delta Configuration—Generation Following Cell Change

In some example embodiments, new delta configuration(s) are generated by a network element (such as, for example, either the base station or network element responsible for access such as a nodeB (NB) and/or the UE) based on the previous cell configuration(s) and the delta configurations provided with respect to the previous cell configuration(s). The newly generated delta configurations are such that they can be applied over the current serving cell configuration to enable a further cell change to take place. In other words, the current serving cell configuration always act as a reference configuration over which the newly generated delta configurations are applied. In some example embodiments, the new delta configurations are generated as required by the UE. In some example embodiments, new delta configurations for target cells with respect to different serving cells are generated by the base station or network element responsible for access and those new delta configurations are provided to the UE for subsequent use. Although the generation of new delta configurations will now be described in more detail with reference to particular types of cell change, it will be appreciated that this approach is applicable to many types of cell change or handover.

FIGS. 2 and 3 illustrates example configurations and show how the network element (in this example, the UE) generates new delta configurations and how the newly generated delta configuration (i.e., ΔConfig 3′) can be applied on the current serving cell configuration to enable a cell change from Cell 2 to Cell 3.

As shown in FIG. 2, the UE is initially being served by cell 1 and stores the full configuration for serving cell 1 (Config 1). The UE is provided with delta configurations for target cells 2 and 3 (ΔConfig 2, ΔConfig 3, i.e. just the changes that would need to be made to the configuration for serving cell 1 (Config 1) to instead be served by cells 2 or 3). Of course, it will be appreciated that more than two target cells may be present and so more than two delta configurations could be provided. When the UE moves from current serving cell 1 to target serving cell 2, it applies the delta configuration for target cell 2 (ΔConfig 2) to the configuration for current serving cell 1 (Config 1) and stores the full configuration for serving cell 2 (Config 2—in this case replacing B(1) with B(2) and replacing C(1) with C(2)).

The UE then generates new delta configurations for target cells 1 and 3 (ΔConfig 1′, ΔConfig 3′, i.e. just the changes that would need to be made to the configuration for serving cell 2 (Config 2) to instead be served by cells 1 or 3). In this example, ΔConfig 1′ stores B(1) and C(1) which when applied to Config 2 would provide Config 1. ΔConfig 3′ stores B(3) and C(1) which when applied to Config 2 would provide Config 3. As mentioned above, where more than two target cells are provided, additional new delta configurations could be generated. Also, delta configurations for target cells 1 and 3 (ΔConfig 1, ΔConfig 3) are not immediately overwritten by the new delta configurations for target cells 1 and 3 (ΔConfig 1′, ΔConfig 3′).

Hence, should the UE move from current serving cell 2 to target serving cell 3, it applies the delta configuration for target cell 3 (ΔConfig 3′) to the configuration for current serving cell 2 (Config 2) and stores the full configuration for serving cell 3 (Config 3). The UE then generates new delta configurations for target cells 1 and 2 in a similar manner to that described above. Likewise, should the UE move from current serving cell 2 to target serving cell 1, it applies the delta configuration for target cell 1 (ΔConfig 1′) to the configuration for current serving cell 2 (Config 2) and stores the full configuration for serving cell 1 (Config 1). The UE then generates new delta configurations for target cells 1 and 2 in a similar manner to that described above.

As shown in FIG. 3, the UE is initially being served by cell 1 and stores the full configuration for serving cell 1 (Config 1). The UE is provided with delta configurations for target cells 2 and 3 (ΔConfig 2, ΔConfig 3, i.e. just the changes that would need to be made to the configuration for serving cell 1 (Config 1) to instead be served by cells 2 or 3). When the UE moves from current serving cell 1 to target serving cell 2, it applies the delta configuration for target cell 2 (ΔConfig 2) to the configuration for current serving cell 1 (Config 1) and stores the full configuration for serving cell 2 (Config 2—in this case replacing B(1) with B(2), replacing C(1) with C(2) and adding E(2)).

The UE then generates new delta configurations for target cells 1 and 3 (ΔConfig 1′, ΔConfig 3′, i.e. just the changes that would need to be made to the configuration for serving cell 2 (Config 2) to instead be served by cells 1 or 3). In this example, ΔConfig 1′ stores B(1), C(1) and E(R) (which indicates that configuration E needs to be removed completely) which when applied to Config 2 would provide Config 1. ΔConfig 3′ stores B(3), C(1) and E(R) which when applied to Config 2 would provide Config 3. Hence, should the UE move from current serving cell 2 to target serving cell 3, it applies the delta configuration for target cell 3 (ΔConfig 3′) to the configuration for current serving cell 2 (Config 2) and stores the full configuration for serving cell 3 (Config 3). The UE then generates new delta configurations for target cells 1 and 2 in a similar manner to that described above. Likewise, should the UE move from current serving cell 2 to target serving cell 1, it applies the delta configuration for target cell 1 (ΔConfig 1′) to the configuration for current serving cell 2 (Config 2) and stores the full configuration for serving cell 1 (Config 1). The UE then generates new delta configurations for target cells 1 and 2 (and any other target cells) in a similar manner to that described above.

A similar approach can be applied on the network side to generate the new delta configurations as required.

An advantage of this approach is that after moving from serving cell 1, Config 1 is maintained only until the new delta configurations for the new target cells (ΔConfig 1′ and ΔConfig 3′) are determined by the network element. The network element may decide to flush the memory containing Config 1 thereafter. Also, the new delta configurations can be determined from information already available to the network element and requires no additional signalling.

FIG. 4 illustrates one approach to generating the new delta configurations by the network element. For each element in the applied AConfigX, do the following (may be performed in parallel):
If an element of AConfigX is not equal to the corresponding element of ΔConfigY, then keep the element from ΔConfigY in ΔConfigY'. In FIG. 4, B(2) in ΔConfig2 is not equal to the corresponding element (B(3)) of ΔConfig3 and so B(3) is kept from ΔConfig3 in ΔConfig3′.
If the element of ΔConfigX does not exist in the ΔConfigY, then add it to updated configuration i.e. ΔConfigY′ with previous cell configuration value. In FIG. 4, C(2) of ΔConfig2 does not exist in ΔConfig3, so C(1) from Config1 is added to ΔConfig3′.
If the element of ΔConfigX does not exist in both ΔConfigY and previous cell configuration, then add an element which indicates that the corresponding element should be removed in ΔConfigY′. In FIG. 4, E(2) of ΔConfig2 does not exist in both ΔConfig3 and Config1, so E(R) is added to ΔConfig3′. In other words the element “remove” means that that element should be removed for the target cell configuration.

Hence, ΔConfig 3′in FIG. 3 is generated based on the above-described implementation procedure. It will be appreciated that the new ΔConfig′ for other target cells can be produced in the same way.

Also, it will be appreciated that ΔConfigY′ can be produced from the previous cell configuration, ConfigX (the current cell configuration) and ΔConfigY since ΔConfigX can be derived, and vice-versa.

### UE Implementation

According to an example embodiment, the UE generates new delta configuration(s) after each cell change such that the new delta configuration(s) can be applied on the current cell configuration to enable a further cell change. This is described with the signaling flow diagrams in FIGS. 5 and 6.

FIG. 5 is for selective activation and it is to be noted that Secondary Node (SN)-initiated Cell (PSCell) change (CPC) is shown as an example, however, example embodiments are equally applicable for Master Node (MN)-initiated CPC without any procedural change.

At step 1, a change from currently serving cell PSCell 0-1 (UE being connected to PSCell 0-1) to potential target or candidate cells PSCell 1-1, PSCell 2-1, and PSCell 2-2 is determined. The determination is e.g. based on UE measurements. At steps 2 to 6, messages are exchanged to provide the UE with the information to enable the change to occur. At steps 7 & 8 the change occurs and the UE applies the delta for PSCell 1-1 to the configuration for PSCell 0-1. At step 9, the UE generates the updated or new delta configurations for PSCell 0-1, PSCell 2-1 and PSCell 2-2 which can be applied to the configuration for PSCell 1-1. At steps 10 to 15, the change to PSCell 1-1 completes. It will be appreciated that the generation of the new delta configurations can occur at any point between steps 8 and 15, depending on desired implementation.

At step 16, a change from PSCell 1-1 to PSCell 2-1 is determined. At step 17, the change occurs and the UE applies the new delta configuration for PSCell 2-1 to the configuration for PSCell 1-1. At step 18, the UE generates further updated or new delta configurations for PSCell 0-1, PSCell 1-1 and PSCell 2-2 which can be applied to the configuration for PSCell 2-1. At steps 19 to 23, the change to PSCell 2-1 completes. Again, it will be appreciated that the generation of the further new delta configurations can occur at any point between steps 17 and 23, depending on desired implementation.

The network can be considered a network with subsequent or consecutive selective activation possibilities, which enables the UE to perform e.g. two cell changes, one after the other, e.g. from PSCell 0-1 to PSCell 1-1, and then to PSCell 2-1 based on one configuration received via e.g. one RRCReconfiguration message in step 6 including e.g. defining condition(s) for cell change from e.g. PSCell 0-1 to PSCell 1-1, from PSCell 0-1 to PSCell 2-1, from PSCell 1-1 to PSCell 2-1, and from PSCell 1-1 to PSCell 0-1. The UE monitors respective condition(s), e.g. when connected to PSCell 0-1 the condition(s) for cell change from e.g. PSCell 0-1 to PSCell 1-1, and from PSCell 0-1 to PSCell 2-1, and if condition for cell change to PSCell 1-1 holds applies cell change to PSCell 1-1. Thereafter, when connected to PSCell 1-1, UE monitors condition(s) for cell change from e.g. PSCell 1-1 to PSCell 2-1, and from PSCell 1-1 to PSCell 0-1, and if condition for cell change to PSCell 2-1 holds applies cell change to PSCell 2-1. The cell change to PSCell 2-1 is the second cell change or a subsequent cell change or a consecutive cell change.

FIG. 6 is for LTM and only an inter-gNB scenario is shown. However, example embodiments are equally applicable to intra-gNB (i.e. inter-Distributed Unit (DU) intra Centralised Unit (CU) and intra-DU intra CU). For the latter scenario, the gNB-1, gNB-2 and gNB-3 (in FIG. 6) represents the same gNB and the cell-1, cell-2 and cell-3 will be under the same (for intra-DU scenario) or different DUs (for inter-DU scenario).

At step 1, the UE is connected to cell 1. At steps 2 to 11, a handover from cell 1 to cell 2 is determined and messages are exchanged to provide the UE with the information to enable the change to occur. At steps 12 & 13 the UE applies the delta configuration for cell 2 to the configuration for cell 1 and the change to cell 2 occurs. At step 14, the UE generates the updated or new delta configuration for cell 3 (and optionally the new delta configuration for cell 1) which can be applied to the configuration for cell 2.

At steps 15 and 16, a handover from cell 2 to cell 3 is initiated. At steps 17 and 18, the UE applies the new delta configuration for cell 3 to the configuration for cell 2 and the change to cell 3 occurs. Optionally, the UE then generates the further new or updated delta configuration for cells 1 and 2 which can be applied to the configuration for cell 3 should a further handover occur.

This approach as potential advantages will now be explained. The UE may not require any additional air interface signaling for delta configurations, e.g.:—After each handover, the UE can update the existing delta configuration(s) and make them still valid; After each handover, the UE can receive new delta configuration(s) without any additional complexity. This approach may not require any additional signaling between network entities (network entities do not need to provide new configurations). The complexity grows linearly for increased number of preparations (desired complexity). This approach may not require any additional memory: Combinatorial delta configurations are not needed (no cell pair delta is needed); No single (for initial deltas) or multiple base (for deltas provided after a handover) configurations needed to be maintained; The network does not need to keep track of base configurations that UE needs to maintain. The UE applies the RRC config e.g. in a single step as the delta configuration is available whenever it is needed:—Delta configurations can be updated after each handover which does not delay any handover procedure. This approach is compatible with updating the serving cell configuration:—The same update solution can be adopted if the serving cell updates its configuration and preserve delta configurations (delta configurations can be updated to preserve intended target cell configuration).

### NW Implementation

According to an example embodiment, the NB (e.g. gNB) generates a new delta configuration such that the new delta configuration(s) will be valid if they are applied on the current configuration after the handover. Typically, new delta configurations are generated for every possible handover cells (in other words, for the current source cell and the target cells as well as for those target cells when handed over to as a new source cell and target cells (including the original source cell). This means that the UE does not need to generate new delta configurations following a cell change and can instead just refer to and apply the new delta configurations provided by the network. This is described with the signaling flow diagrams in FIGS. 7 and 8.

FIG. 7 is for selective activation and it is to be noted that SN-initiated CPC is shown as an example, however, example embodiments are equally applicable for MN-initiated CPC without any procedural change.

At steps 1 to 5, a change from PSCell 0-1 to either PSCell 1-1 or PSCell 2-1 is determined. Cell configuration and delta configurations are exchanged between the source and target base stations.

At step 6, the source MN can also generate single set of modified new or updated delta-configurations for PSCell 1-1 and PSCell 2-1 and PSCell 2-2 which contains values for all the affected parameters taken from the received delta-configuration and PSCell 0-1. In this case the modified-delta configuration of each target cell will include same set of parameters. This set of parameters are all the affected parameters from each delta-configuration. In this case 3 target delta configurations will be sufficient.

At step 7, these modified delta configurations are included in the RRC Reconfiguration message.

At steps 8 to 15, the UE changes from PSCell 0-1 to PSCell 1-1 by applying the PSCell 1-1 new delta configuration to the PSCell 0-1 configuration.

At steps 16 to 22, the UE changes from PSCell 1-1 to PSCell 2-1 by applying the PSCell 2-1 new delta configuration to the PSCell 1-1 configuration. It will be appreciated that a hybrid approach is possible where the UE also generates new delta configurations on a cell change in a similar manner to that described above. Such an approach may be useful when the new delta configurations provided by the network is incomplete.

FIG. 8 is for LTM and only an inter-gNB scenario is shown as an example, however, example embodiments are equally applicable to intra-gNB (i.e. inter-DU intra CU and intra-DU intra CU). Herein, the gNB-1, gNB-2 and gNB-3 represents the same gNB and the cell-1, cell-2 and cell-3 will be under the same (for intra-DU scenario) or different DUs (for inter-DU scenario).

At step 1, the UE is connected to cell 1.

At steps 2 to 6, cells 2 and 3 are prepared for handover. gNB-2 and gNB3 provide their respective delta configurations with respect to the current configuration of cell 1.

At step 7, gNB-1 generates updated delta configurations for cell 3 (and optionally for cell 1) which can be applied to the cell 2 configuration following a handover to cell 2. Likewise, the gNB-1 could generate updated delta configurations for cell 2 (and optionally for cell 1) which can be applied to the cell 3 configuration following a handover to cell 3.

At step 8, the delta configurations for the target cells and the updated delta configurations are provided with the RRC Reconfiguration message. At step 8, these are stored in the UE.

At steps 11 to 14, handover is performed from cell 1 to cell 2. The UE applies the delta for cell 2 to the configuration for cell 1 to arrive at the configuration for cell 2.

At steps 15 to 18, handover is performed from cell 2 to cell 3. The UE applies the updated delta for cell 3 to the configuration for cell 2 to arrive at the configuration for cell 3.

Again, it will be appreciated that a hybrid approach is possible where the UE also generates new delta configurations on a cell change in a similar manner to that described above. Such an approach may be useful when the new delta configurations provided by the network is incomplete.

According to one example embodiment, the NW sends the newly generated delta in the form of nested configurations e.g. each candidate cell contains the delta configurations of the further candidate cells. Such modelling is shown in FIG. 9.

According to one example embodiment, not all the candidate cell configurations are in the form of delta configurations. In other words, some configurations are delta configurations over the current serving cell and some configurations are full configurations.

Advantages of NW relevant methods include: the UE stores all the possible delta configurations (e.g., delta needed for moving from cell 1 to cell 2, delta needed for moving from cell 2 to cell 3, delta needed for moving from cell 2 to cell 1); and the network has a better control.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although example embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-63. (canceled)

64. A user equipment configured to support connection towards a radio access network, the user equipment comprising:
at least one processor; and
at least one memory storing instructions that, when executed by the at least one processor, cause the user equipment at least to:
establish a connection between the user equipment and a first network node of the radio access network, the first network node supporting a first cell,
derive in the user equipment a full configuration of the first cell,
receive in the user equipment first delta configuration information related to a cell change from the first cell towards a second cell and second delta configuration information related to a cell change from the first cell towards a third cell,
in response to a cell change towards the second cell, derive a full configuration of the second cell based on the full configuration of the first cell and the first delta configuration information to connect to the second cell, and
generate updated second delta configuration information for performing a cell change from the second cell towards the third cell, the generation of the updated second delta configuration information being based on the configuration information available to the user equipment prior to the cell change towards the second cell.

65. The user equipment according to claim 64, wherein the generation of the updated second delta configuration information is based on the full configuration of the first cell, the first delta configuration information and the second delta configuration information.

66. The user equipment according to claim 64, wherein the generation of the updated second delta configuration information is based on the full configuration of the first cell, the full configuration of the second cell and the second delta configuration information.

67. The user equipment according to claim 64, wherein the generating occurs following the cell change from the first cell to the second cell.

68. The user equipment according to claim 64, wherein the generating occurs between the cell change from the first cell to the second cell and a subsequent cell change.

69. The user equipment according to claim 64, wherein the generating identifies differences between the first delta configuration information when applied to the full configuration of the first cell and the second delta configuration information when applied to the full configuration of the first cell and incorporates those differences into the updated second delta configuration.

70. The user equipment according to claim 64, wherein the generating identifies when an element or parameter has a different value in the second delta configuration information to a corresponding element or parameter in the first delta configuration information and incorporates the different value from the second delta configuration information for the element or parameter into the updated second delta configuration information.

71. The user equipment according to claim 64, wherein the generating identifies when an element or parameter in the first delta configuration information has no a corresponding element or parameter in the second delta configuration information and incorporates a corresponding element or parameter from the full configuration of the first cell into the updated second delta configuration information.

72. The user equipment according to claim 64, wherein the generating identifies when an element or parameter in the first delta configuration information has no a corresponding element or parameter in the full configuration of the first cell and incorporates an indication into the updated second delta configuration information that the element or parameter should be removed.

73. The user equipment according to claim 64, wherein the instructions cause the user equipment at least to:
in response to a further cell change towards the third cell, derive a full configuration of the third cell based on the full configuration of the second cell and the updated second delta configuration to connect to the third cell.

74. The user equipment according to claim 64, wherein the instructions cause the user equipment at least to:
repeat the generating of updated delta configuration information in response to the further cell change to the third cell.

75. The user equipment according to claim 64, wherein the instructions cause the user equipment at least to:
receive the full configuration of the first cell, the first delta configuration information and/or the second delta configuration information using RRC signalling.

76. The user equipment according to claim 64, wherein the first network node comprises at least one of or supports functionality of at least one of: a base station, a 5G gNB, a Centralised Unit, a Distributed Unit, a secondary node, a source node or a source secondary node.

77. The user equipment according to claim 64, wherein the user equipment supports dual connectivity to a master node and a secondary node.

78. The user equipment according to claim 64, wherein the first cell is at least one of a primary secondary cell or primary secondary cell supported by a source secondary node, or a source primary secondary cell, or a currently serving cell.

79. The user equipment according to claim 64, wherein the second cell is at least one of a primary secondary cell or primary secondary cell supported by a first target secondary node, or a target primary secondary cell, or a target serving cell.

80. The user equipment according to claim 64, wherein the third cell is at least one of a primary secondary cell or primary secondary cell supported by a second target secondary node, or a target primary secondary cell, or a target serving cell.

81. The user equipment according to claim 64, wherein the instructions cause the user equipment at least to:
receive information related to a conditional cell PSCell change for moving from the first to the second cell and, if the condition for the cell PSCell change to the second cell holds, then perform random access to the second cell.

82. The user equipment according to claim 64, wherein the instructions cause the user equipment at least to:
when random access to the second cell is successful, store the updated second delta configuration information and delete the second delta configuration information.

83. The user equipment according to claim 64, wherein the instructions cause the user equipment at least to:
receive information related to a conditional cell PSCell change for moving from the first to the third cell and, if the condition for the cell PSCell change to the third cell holds, then perform random access to the third cell.

84. The user equipment according to claim 64, wherein the user equipment is configured for subsequent selective activation.

85. The user equipment according to claim 64, wherein the user equipment is configured using at least one RRC reconfiguration message.

86. The user equipment according to claim 64, wherein the instructions cause the user equipment at least to:
receive configuration information for performing L1 measurements.

87. The user equipment according to claim 64, wherein the instructions cause the user equipment at least to:
send an L1 measurement report including second cell information towards the first cell or source network node and receiving a trigger to handover to the second cell.

88. The user equipment according to claim 64, wherein the user equipment is configured for dynamic switching.

89. A non-transitory computer readable medium comprising program instructions stored thereon for performing at least the following:
establishing a connection between the user equipment and a first network node of the radio access network, the first network node supporting a first cell,
deriving in the user equipment a full configuration of the first cell,
receiving in the user equipment first delta configuration information related to a cell change from the first cell towards a second cell and second delta configuration information related to a cell change from the first cell towards a third cell,
in response to a cell change towards the second cell, deriving a full configuration of the second cell based on the full configuration of the first cell and the first delta configuration information to connect to the second cell, and
generating updated second delta configuration information for performing a cell change from the second cell towards the third cell, the generation of the updated second delta configuration information being based on the configuration information available to the user equipment prior to the cell change towards the second cell.
